(19) United States
(12) Patent Application Publication
(10) Pub. No.: US 2007/0104905 A1
(43) Pub. Date: May 10, 2007

(54) Reinforced bags

(76) Inventor: Thomas M. Floyd JR., Moore, SC (US)

Correspondence Address: J. BENNETT MULLINAX, LLC, P. O. BOX 26029, GREENVILLE, SC, 29616-1029, US

(21) Appl. No.: 11/268,956

(22) Filed: Nov. 8, 2005

(51) Int. Cl. B60R 21/16

(52) U.S. Cl. 428/36.1; 428/35.2

(57) ABSTRACT

A bag formed from a fabric reinforced film is provided. The bag substrate comprises a biaxially oriented thermoplastic film of a polypropylene or polyester. The biaxially oriented film layer may include a foil or metal layer. The film layer further contains a fabric backing. The resulting bag is resistant to water, greases, fats, and oils and provides an improved printing surface for graphics and enhances the strength and reduces the basis weight of the resulting bag.

### FIELD OF THE INVENTION

This invention is directed towards a bag having a tubular form comprising a reinforced biaxially oriented flexible film material.

### BACKGROUND OF THE INVENTION

This invention relates to an alternative for conventional stand-up pouches and multi-wall bags. Such bags are frequently used in packaging granulated or powdered products such as animal feed, chemicals, powdered milk, and other pourable types of products. Bags and pouches within this industry are frequently referred to as self-opening style (SOS) bags, pinched-bottom or open-mouthed bags, and valve sacks which are hereinafter collectively referred to as multi-wall bags. A multi-wall bag frequently includes a tear open tab located at least partially inside the bag and which is folded with the pinched closure between the walls of the bag.

One form of a multi-wall paper bag may be seen in reference to U.S. Pat. No. 3,687,356 assigned to St. Regis Paper Company and which describes single-wall and multi-ply wall gusseted type bags. Multi-wall bags of this basic construction have been widely used for the packaging of animal feed, particularly dog and cat food.

It is known that the exterior paper ply of multi-wall bags used within the pet food packaging industry may be treated with fluorocarbons such as Scotch Guard® brand FC807 (3M) protectants so as to provide grease/oil resistance to the exterior surface of the outermost bag ply. The grease/oil stain prevention properties are achieved by adding the fluorocarbon to the pulp prior to making the paper. Additionally, clay-coated papers may have additional fluorocarbon added to the clay slurry prior to coating the paper. Such treatments prevent grease and oil from sticking to the constituent paper fibers. Such chemical treatment has been adequate to provide grease/oil resistance to the bag's exterior surface while permitting the application of graphics and printing using conventional printing techniques.

Useful background information with respect to multi-wall bag containers may be found in the publication entitled, Reference Guide For The Paper Shipping Sack Industry, Copyright 1991, published by the Paper Shipping Sack Manufacturer's Association, Inc., of Tarrytown, N.Y., a 51-page guide which is incorporated herein by reference. The reference guide discusses paper finishes and treatments including use of fluorochemical agents to make paper resistant to oil and grease.

It is also known in the art to provide for high strength bag containers from plastic film. One such disclosure is seen in reference to U.S. Pat. No. 4,340,558 assigned to Colgate-Palmolive Company in which an extruded film is used to enclose a reinforcing scrim material. The resulting scrim, which is encapsulated within the extruded plastic film, is thereafter used to provide for a plastic pouch or bag.

U.S. Pat. No. 4,264,659, assigned to E. I. DuPont de Nemours & Company provides for a woven polyethylene tape which is used with an oriented polyethylene film to produce a sandwich type structure useful for making industrial sacks.

While a variety of multi-wall bags and plastic bag structures are known, there remains room for improvement and variation within the art.

### SUMMARY OF THE INVENTION

It is one aspect of one of the present embodiments of the invention to provide a film substrate suitable for use as a constituent material for a bag. The film material provides for a substrate which can be constructed having the shape and dimensions of a conventional multi-wall bag while having improved strength and puncture resistance.

It is yet another aspect of at least one of the present embodiments of the invention to provide a substrate for making bags having a layer of biaxially oriented film which is reinforced with a layer of a scrim material. The resulting film/scrim layer may be used to construct a bag having increased tear resistance, puncture resistance, and strength properties compared to a multi-wall bag having conventional construction of one or more layers of paper plies.

It is yet another aspect of at least one of the present embodiments of the invention to provide a high strength, puncture resistant plastic film which may be used to construct a bag such as a flat tube, gusseted, or similar bag, having improved strength and tear resistant properties while having a lower basis weight than a corresponding strength multi-ply paper bag.

It is yet another aspect of at least one of the present embodiments of the invention to provide a pet food gusseted bag in which the outer layer comprises a film layer of a biaxially oriented thermoplastic material such as polypropylene or polyester. An extruded thermoplastic layer and/or a glue layer, such as a conventional tie resin, polyurethane adhesive, or polyester adhesive, may be used to bond a reinforcing fabric such as a nonwoven scrim layer to the outer film layer. The resulting fabric backed film provides a substrate which is useful in forming a gusset-type bag.

It is another aspect of at least one of the present embodiments of the invention to provide for a bag construction having an exterior layer of a biaxial oriented film such as polypropylene or polyester. The film layer provides a bag surface having improvements in graphics, printing capabilities, and water vapor transmission rates and permits bag dimensions of face width, tube length, and, when present, a gusset width to be easily varied. An inner surface of a biaxially oriented film has secured thereto a reinforcing layer of a scrim. The scrim may be provided by a woven, nonwoven, or spun bond layer. The scrim layer may be attached using a conventional adhesive or through an extruded polyolefin layer. The added strength provided by the scrim reinforced film substrate enhances the strength of the resulting bags such that standard sizes of useful bag dimensions having a single film layer all have adequate strength for conventional bag contents such as pet food, cat litter, bird seed, and similar materials.

It is yet another aspect of at least one of the present embodiments of the invention to provide a fabric backed biaxially oriented film suitable for use to construct a stand-up pouch container or bag in which a biaxially oriented film provides the outermost layer. An inner layer of the biaxially oriented film has attached thereto a reinforcing layer of a scrim material. The opposing surface of this scrim material may then be coated with an additional barrier layer such as an extrusion coating of high density polyethylene or by having an additional film layer, such as an oriented polypropylene or other grease resistant film, attached thereto. The resulting film material provides moisture resistance along with increased grease, fat, and oil resistance. The outer film surface further provides an improved printing surface as compared to the paper exterior of a conventional multi-wall paper bag.

It is yet another aspect of at least one of the present embodiments of the invention to provide for a bag in which the outermost film defines a coated surface layer. Preferably, the film layer comprises a biaxially oriented polyester, polypropylene, or other oriented thermoplastic film layer. Opposite the coated surface layer, a reinforcing fabric backing is attached to the film layer. The resulting film provides a substrate which permits a bag using a single layer of coated film which has a reduced weight and greater strength than conventional three-ply or four-ply multi-wall bags using paper based constituents.

These and other features, aspects, and advantages of the present invention will become better understood with reference to the following description and appended claims.

### BRIEF DESCRIPTION OF THE DRAWINGS

A fully and enabling disclosure of the present invention, including the best mode thereof, to one of ordinary skill in the art is set forth more particularly in the remainder of the specification, including reference to the accompanying drawings.

FIG. 1 is a perspective view of a pinch-bottom bag construction in accordance with one aspect of the invention.

FIG. 2 is a perspective view of an alternative embodiment of a pinch-bottom bag constructed in accordance with one aspect of the present invention.

FIGS. 3 through 6 are cross sections of bag substrates that are used to provide for gusseted or pouch type bags in accordance with one or more figures of the present invention.

FIG. 7 is a perspective view of one embodiment of a fabric backed film substrate useful in the construction of a bag or pouch.

### DESCRIPTION OF THE PREFERRED EMBODIMENT

Reference will now be made in detail to the embodiments of the invention, one or more examples of which are set forth below. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used on another embodiment to yield a still further embodiment. Thus, it is intended that the present invention cover such modifications and variations as come within the scope of the appended claims and their equivalents. Other objects, features, and aspects of the present invention are disclosed in the following detailed description. It is to be understood by one of ordinary skill in the art that the present discussion is a description of exemplary embodiments only and is not intended as limiting the broader aspects of the present invention, which broader aspects are embodied in the exemplary constructions.

In describing the various figures herein, the same reference numbers are used throughout to describe the same material, apparatus or process pathway. To avoid redundancy, detailed descriptions of much of the apparatus once described in relation to a figure is not repeated in the descriptions of subsequent figures, although such apparatus or process is labeled with the same reference numbers.

As used herein, the term “fabric backing” refers to a natural or synthetic fabric including various types of scrims which may include open net or mesh, gauzes, loose or open weave knits, woven fabrics, non-woven knit fabrics, felt, and similar fiber-containing webs of natural or synthetic fibers including spun bond materials.

As used herein, the term “bag” refers to either gusseted, flat tube bags, or similar bag structures which are conventionally made of single or multi-plies of paper and/or film.

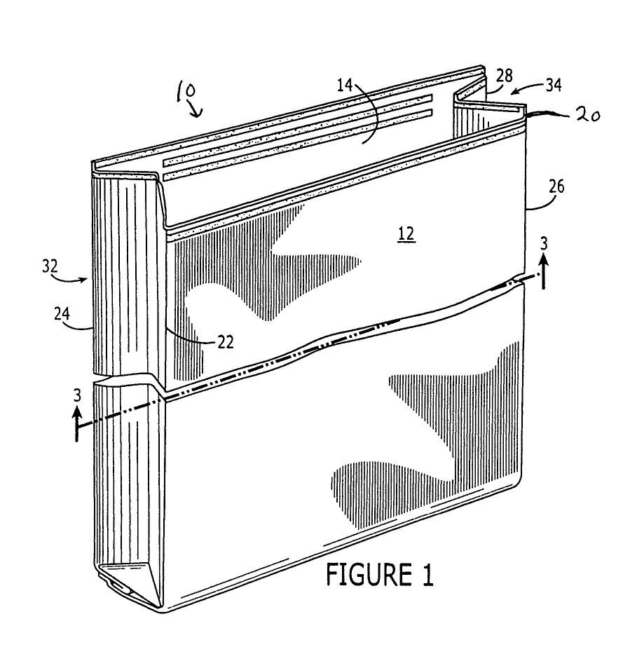

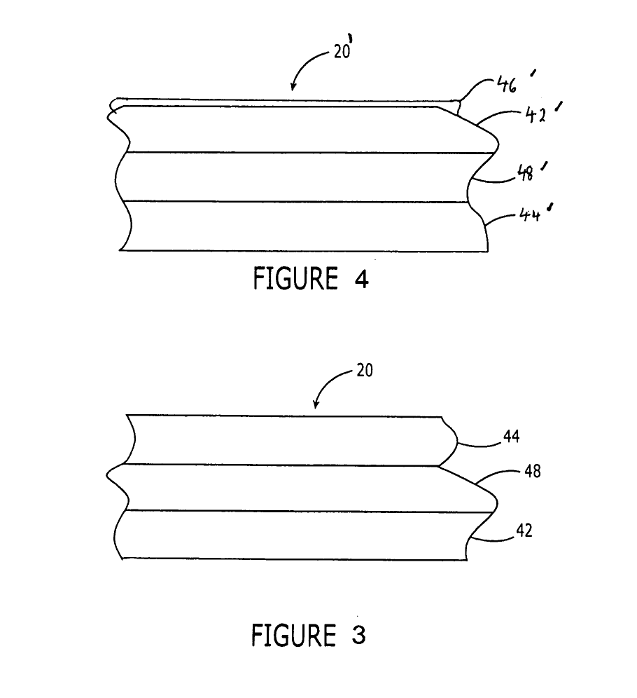

As seen in reference to FIG. 1, an exemplary, non-limiting embodiment of the present invention is directed to a stand-up pouch or multi-wall bag having a pinched closure at one end. As seen in reference to FIG. 1, the bag 10 defines at least one pinch-closable end and is formed from a substrate layer 20 which is folded to form a pinch closure. Substrate 20 (FIG. 3) comprises a biaxially oriented film in combination with a fabric backing. The bag has a front wall 12 and an oppositely disposed rear wall 14, rear wall 14 extending above the front wall 12 at one end of the tube when the bag is in its assembled condition as illustrated. As seen in FIG. 1, the bag 10 defines a series of forward fold lines 22, 24, 26, and 28. Bag 10 further defines a pair of oppositely spaced gussets 32 and 34 which are positioned between the respective front and rear walls of bag walls 12 and 14.

As seen in reference to FIG. 7, a biaxially oriented film 44 is illustrated having a fabric backing 42 adhered thereto. In the embodiment shown in FIG. 7, fabric backing 42 may be in the form of a nonwoven fabric scrim. While not illustrated, the fabric backing 42 is adhered to film layer 44 using conventional adhesive techniques well known in the art. The fiber or string in the components within a fabric backing 42 have been found to provide increased strength to the film substrate. The increased strength and durability also includes the ability of the substrate to be formed into a gusset type bag having numerous fold lines and seams. The substrate is particularly well suited for use with hot melt adhesives to form seals along the bag seams. The hot melt adhesive helps form a water vapor resistance which improves the overall water vapor barrier properties of the packaging.

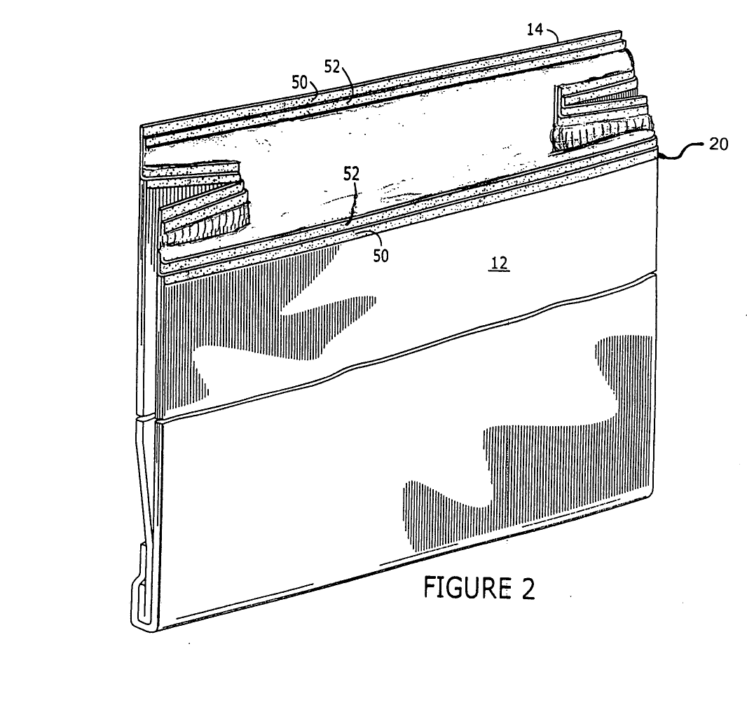

In reference to FIG. 2, a multi-ply bag embodiment is referenced having an inner layer 52 of a substrate 20 and which further comprises an outer ply 50 of a coated paper as described in Assignee's U.S. patent application having Ser. No. 10/721,807, entitled “Multi-wall Bag” filed on Nov. 25, 2003, and which is incorporated herein by reference. Alternatively, an outer ply 50 may be provided of conventional uncoated natural kraft paper, converter kraft, or other conventional paper stock. The construction of single-wall and multi-wall gusseted-type bags using paper plies is well known in the art as may be found in reference to U.S. Pat. Nos. 3,687,356 and 6,599,016 which are incorporated herein by reference.

Exemplary bags seen in FIGS. 1 and 2 may be constructed from a film substrate in which the film substrate comprises a biaxially oriented film. Exemplary embodiments of a film substrate 20 reflecting one or more aspects of the invention may be seen in reference to FIGS. 3 through 7 and the accompanying descriptions herein.

As seen in reference to FIG. 3, one construction for a substrate 20 comprises a biaxially oriented film 44. Suitable materials for film layer 44 include polyester, polypropylene, and other polyolefin films. Film 44 may provide a useful exterior surface of an assembled bag. Film 44 provides for a printable surface which, when used with appropriate inks, allows for enhanced graphics having greater sharpness and vibrancy as compared to images printed on conventional kraft papers.

One suitable film for layer 44 comprises a biaxially oriented polypropylene film having a melting point of between about 325° F. to about 330° F. Further, it has been found that having the acrylic coating applied to the surface of the film provides for an improved print ink receiving surface and improves the film's receptivity to inks and hot melts. Suitable polypropylene films, including films having acrylic coatings, are commercially available from AET Films, Inc. (Newcastle, Del.) and Vifan, a division of Vibac (Morristown, Tenn.).

The strength, as measured by impact resistance of substrate 20 is significantly enhanced when an interior surface, i.e, the non-print surface, of film layer 44 has bonded thereto a fabric backing layer 42. Fabric backing layer 42 may be secured to film 20 using an adhesive layer 48. Adhesive layer 48 may be any conventional adhesive such as a polymer-based, pressure-sensitive adhesive such as Cybertech, H.P. Fuller, or National Starch and Adhesive.

The fabric backing preferably has a discernable fibrous component which is maintained following the attachment of the fabric backing to the film layer 44. The fibrous nature of the fabric backing has been found to offer significant improvements in the strength of the resulting substrate 20. Improvements in the strength of substrate 20 facilitate the production of a gusset-type bag having improved strength and a lower basis weight as discussed in greater detail below.

When polyester film is used, a useful thickness of the biaxially oriented film layer is about 48 gauge, although a range of about 30 gauge to about 98 gauge is believed useful. In the case of biaxially oriented polypropylene, a film thickness of about 55 gauge has been found useful, although it is believed that a range of about 40 gauge to about 100 gauge is also useful. Applying a fabric backing to a biaxially oriented polyester or polypropylene film may be carried out using conventional adhesive or lamination techniques well known within the art.

As seen in reference to FIG. 4, an alternative embodiment of the present invention is set forth in which the film substrate 20′ may have a conventional paper layer 46′ bonded to the surface of the fabric backing 42′. A paper layer 46′ may be bonded to the surface of the fabric backing 42′ using a conventional adhesive 48′, including the pressure-sensitive adhesives described above.

The biaxially oriented film layer 44′ may be used as part of a substrate 20 to form a pouch or multi-wall bag similar to that seen in FIG. 2. Paper layer 46′ may be selected from any number of conventional bag papers including grades of kraft paper. Additionally, paper layer 46′ may include a coated paper layer such as the coated paper described in Applicant's co-pending application having Ser. No. 10/721,807, and the entire teachings of which are incorporated herein by reference. The biaxially oriented thermoplastic film layer 44′ may optionally include a foil or metal layer as best described in applicant's co-pending application Ser. No. 10/721,807.

By way of example, an aluminum foil layer may have a thickness of about 1 to 2 angstroms with an optical density (OD) ranging from about 1.5 to about 3.5. On top of the foil layer, a biaxially oriented thermoplastic film layer of polypropylene or polyester may be applied. Preferably, the metal layer and the thermoplastic film layer may be applied in a single step using a vacuum metallized oriented polypropylene sheet. Suitable metallized oriented polypropylene film is available from AET Films, Inc. (New Castle, Del.), Exxon-Mobil, and Vifan (Morristown, Tenn.). Following metallization of the biaxially oriented film layer, the fabric backing may be applied followed by the application of the outermost paper layer. Optionally, the outer layer may be provided by a metallized coated paper such as a vacuum metallized oriented polypropylene sheet as described in Applicant's co-pending application.

If a paper layer is used for substrate 46′ as seen in reference to FIG. 4, an outer polyolefin layer may be applied as a film or extrusion layer to provide a smooth, outer surface to the paper or film layer substrate 46′. As a result, the polyolefin layer may be used to provide a smooth, even exterior surface which facilitates subsequent printing of bag graphics onto a paper layer 46′ using, for example, conventional flexo printing or gravure printing techniques.

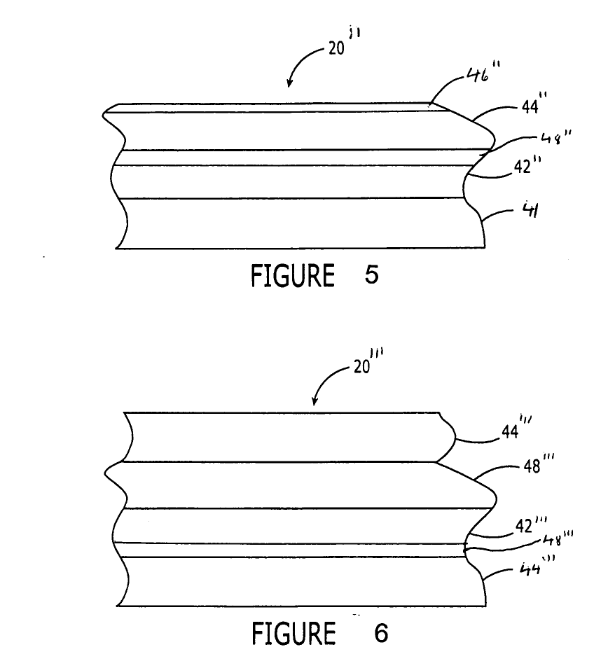

An alternative material for a pouch or bag may be seen in reference to the substrate 20″ seen in reference to FIG. 5. Substrate 20″ includes a biaxially oriented film layer 44″ which may provide the exterior printed surface for a resulting bag. Optionally, the exterior surface of film layer 44″ may have applied thereto an additional structural paper member or coated paper 46″ as described in reference to FIG. 4.

The interior surface of film layer 44″ has a fabric backing 42″ such as a nonwoven scrim affixed thereto. The interior surface of fabric backing 42″ has an extrusion coating of a grease barrier layer 41 such as high density polyethylene (HDPE) or other suitable polymer.

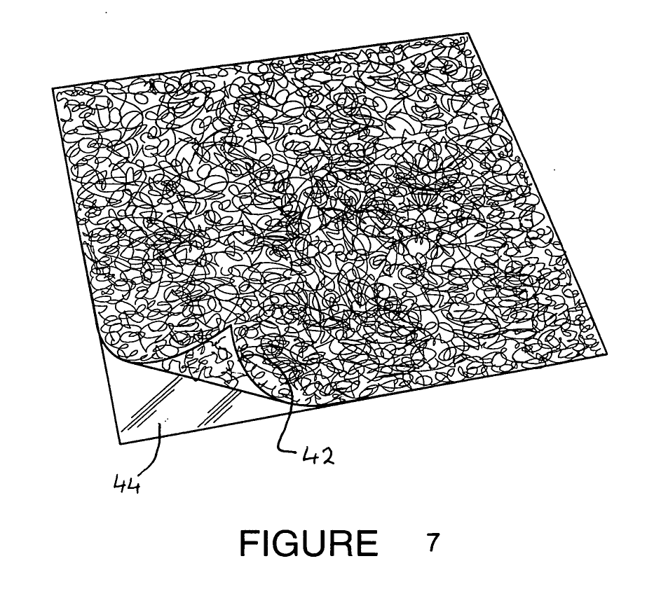

An additional embodiment for a pouch or bag may be seen in reference to substrate 20′″ set forth in FIG. 6. Substrate 20′″ includes a first biaxially oriented film layer 44′″ which may be used to provide an exterior surface for a resulting pouch, bag, or gusset-type bag. An adhesive layer 48′″ is used to attach a fabric backing 42′″ to an interior surface of film layer 44′″. An additional adhesive layer 48′″ may be used to attach a second biaxially oriented film layer 44′″ to an inner surface of fabric backing layer 42′″. The resulting substrate 20′″ provides for a fabric backing layer 42′″ which is sandwiched between two separate film layers 44′″. The respective first and second film layers 44′″ may be provided from identical films or may use different films (including one film being a non-oriented barrier film) to provide the resulting fabric reinforced laminate.

The second barrier film layer 44′″ provides a grease resistant barrier and defines the inner product contact surface for a resulting bag. Alternatively, the second film layer 44′″ and associated adhesive layer 48′″ may be substituted by an extrusion coating layer of a grease resistant barrier material such as HDPE or other suitable thermoplastic extrusion coatings.

In accordance with the embodiment discussed above, it has been found that the biaxially oriented film having a fabric backing offers several advantages with respect to the construction of a gusset bag or standard pouch. Foremost, the biaxially oriented thermoplastic film layers 44, 44′, 44″, and 44′″ have been found to provide an improved printing surface as opposed to coated or uncoated kraft papers. The improved printing surface is achieved, in part, by providing a smoother and non-abrasive printing surface. As a result, the printing surface requires less ink to be applied while enhancing the sharpness and contrast of the applied inks. Consequently, ink printing costs are lowered. The resulting graphics are cleaner and crisper since the absorptive paper layer does not directly interact with or absorb the ink as occurs with chemically treated papers.

The use of the fabric reinforced biaxially oriented film substrate as set forth in the various embodiments offers additional advantages in printing operations. By eliminating the need to use various types of kraft paper for varying bag constructions, there is no longer a need to switch inks based upon the type of paper. When various types of film substrates are used as a bag exterior surface as described herein, the resulting substrates are all compatible with a single type of ink and do not require time consuming and costly ink switching at the printing stage.

The substrate 20 as set forth in FIG. 3 may be used directly to form a bag as seen in FIG. 1 or may provide a reinforcement layer for a bag which uses a conventional kraft type paper ply as seen in FIG. 2. When such an embodiment is used as seen in FIG. 4, the exterior bag surface of kraft paper may be printed with conventional kraft ink using standard bag production techniques. The reinforcement properties of the underlying substrate 20 provide significant reinforcement to a multi-wall bag using a kraft paper as a bag exterior material.

As best seen in reference to Table 1 below, the addition of a fabric backing to a biaxially oriented film significantly increases the impact resistance as measured by a standard DART drop test. The fabric backed samples, compared to the control samples of kraft and/or coated paper (Ontic), demonstrate significant improvements in impact resistance.

TABLE 1
Dart Drop Data
ASTM D1709-98

| | Mean(J) | Std. Dev(J) |
|---|---|---|
| Adhesive Laminate | 6.091 | 0.0300 |
| 50# MFpaper | 0.4491 | 0.0030 |
| 50#MF Tea Kraft | 0.8197 | 0.0250 |
| Ontic (white) | 0.9833 | 0.0301 |

Additionally, when substrate 20 is used as an outer substrate for a multi-wall bag, the resulting bag has significantly improved strength properties and tear resistance compared to a similar bag made with either an uncoated kraft paper or a biaxially oriented film layer.

The use of the biaxially oriented fabric reinforced film for a multi-wall bag construction permits a lightweight, thin bag to be provided which meets the requirements of ICC Rule 40. Heretofore, compliance with ICC Rule 40 effectively required multi-wall bags having multiple paper layers. The use of a reinforced film layer for bag construction allows the performance standards set forth in ICC Rule 40 to be met and does so using a material which results in lower shipping weight and lower volume while achieving a bag having greater strength and integrity.

TABLE 2

| Structures | Basis Weight | Curl | Tear | Elongation | Stiffness | Puncture | Tensile |
|---|---|---|---|---|---|---|---|
| Tested | #/Ream | Inches | (lb-force) | % | (lb-force) | (lb-force) | (lb-force) |
| Control 1 | 71.46 | 0.50 | 0.30 | 6.658 | 152.25 | 21.333 | 31.83 |
| (3-ply) | | | | | | | |
| Control 2 | 129.40 | 0.13 | 0.40 | 2.550 | 213.50 | 34.503 | 66.25 |
| (4-ply) | | | | | | | |
| Control 3 | 142.83 | 0.13 | 0.42 | 1.721 | 177.50 | 22.911 | 72.41 |
| Control 4 | 73.15 | 0.50 | 0.25 | 7.275 | 141.00 | 18.504 | 48.20 |
| Sample | 76.72 | 0.25 | 0.50 | 22.551 | 102.00 | 28.671 | 41.84 |
| ESP-M | | | | | | | |

As best seen in reference to Table 2, a comparison is made between the various structures. The material used in Control 1 is a gusseted bag having a 3-ply construction in which one of the ply layers is reinforced with a biaxially oriented polyester laminated with bleached paper. Control 2 is a 4-ply bag having a layer of a biaxially oriented film coated paper. The sample labeled “Control 3” reflects a conventional kraft paper 4-layer, multi-ply bag. The bag structure labeled “Control 4” is a 3-layer, multi-ply bag utilizing a metallized oriented polyester laminated to a natural kraft paper. The “Sample ESP-M” bag is made from a single laminate of a biaxially oriented polyester/fabric backed/biaxially oriented polypropylene laminate similar to the structure as seen in reference to FIG. 7. As seen from the data in Table 2, the sample bag using the fabric laminated film sandwich construction offers excellent puncture resistance and tensile strength using a material which has a significantly reduced basis weight compared to 4-ply construction.

As seen in reference to Table 2, the sample bag according to an embodiment of the present invention (ESP-M) provides for a structure which affords excellent puncture resistance in combination with a low basis weight. The control structures as represented in Controls 1, 3, and 4 failure to achieve similar puncture resistance. Only a film layer reinforced 4-ply structure (Control 2) provides a greater puncture resistance although at the requirement of using multiple plies having a much greater basis weight and greater material cost.

The substrate 20 is useful for single-wall bags, multi-ply bags, or stand-up pouches in which the outermost ply is of a coated paper as described herein. The resulting bag has advantages in terms of the mechanical packaging capabilities of the bag. The exterior, i.e., printed surface of the bag has an extremely smooth and glossy texture. Suction belts and cups used on mechanical packaging equipment are able to better grasp the bag. The improved gripping results in bag processing in which the outer face is not torn or damaged by the use of overly aggressive handling techniques or application of excessive vacuum pressure to the handling equipment.

For instance, the fabric backed film substrates provided for herein is useful in producing tubular bags such as those disclosed in U.S. Pat. No. 4,461,031 entitled, “Tubular Bag and Method of Making the Same”; U.S. Pat. No. 4,356,853, entitled, “Bag”; and U.S. Pat. No. 6,729,109, entitled “Method and Apparatus For Making Flat Bottom Bags”; the specifications and drawings of which are incorporated herein by reference in their entirety. These and similar bags known in the prior art can be constructed using at least one layer of the fabric-backed film as a bag substrate material. Compared to an unreinforced paper or film substrate, a bag made using the fabric backed film substrate as disclosed herein provides for improvement in bag properties as noted in Tables 1 and 2.

Use of the fabric backed film substrates provides for improved bag strength. Consumers frequently grab a bag along an upper seam or, when present, a gusset wall. The fabric reinforced film provides superior tear resistance to the bag. Consequently, the integrity of the bag is maintained along key stress points during handling. This additional strength also facilitates the incorporation of an optional handle into the bag, such handles being well known in the art.

Further, bags made with a fabric reinforced biaxially oriented film are more resistant to punctures and tears. When the fabric reinforced film is used as an exterior layer of the resulting bag, the amount of visible surface abrasion which occurs during handling is significantly reduced. The exterior layer comprises the print surface upon which packaging graphics are printed. As a result, the improved strength and tear resistance maintains the shelf appeal of the packaging. Consumers perceive visible tears or abrasions in bag packaging as an indication of underlying weakness of the bag and/or a compromise of the product's integrity. By reducing the incidence of tears and abrasions in the bag exterior, retailers do not have to discount or remove as much product as a result of damaged packaging.

An additional benefit of a fabric reinforced film substrate is that bags made from the substrate have improved resistance to external moisture damage. Heretofore, conventional pet food bags and similar products had an exterior ply layer which offered poor resistance to moisture. As a consequence, exposure of the bag to rain or moisture would greatly weaken the bag strength. Further, visible moisture damage lessened the attractiveness of the bag graphics and was frequently perceived by the consumers as indicative of potentially spoiled or damaged goods. The use of the fabric backed film, particularly as an exterior substrate, substantially increases the resistance of the bag to moisture. This resistance has positive effects on the bag strength as well as the appearance of the bag graphics.

The biaxially oriented fabric backed film provides a more stable outer ply for use in the bag or pouch converting process. Not only will the use of the film substrate eliminate the requirement of paper plies, the substrate results in finished bags having a lower basis weight and increased strength. As a result of the lower basis weight, both shipping and storage costs are reduced. In addition, the substrate provides for finished bags which can be packaged with greater efficiency. As a result of the reduced volume of the bag material, the storage, shipping, and handling costs of the unfilled bags is significantly reduced. The increased bag strength also provides increased efficiency in the bag making operation as the fabric backed film allows for higher bag speeds and tuber speeds to be utilized.

A further advantage of the fabric backed film substrates is that the substrate avoids moisture problems associated with conventional kraft ply layers. Paper plies often become brittle during the printing and/or lamination process which results in an excessive drying of the paper. The fabric backed film substrates discussed herein exhibit no fluctuation in moisture content and therefore provides for easier handling and bag manufacturing. The resulting bags also prevent moisture damage of the bag's contents.

A significant time factor of printing on prior art paper involves the drying of the paper following application of one or more ink colors. Using the biaxially oriented fabric backed film reduces the ink volume by a factor of two to three without loss of color intensity or hues. Since printing occurs directly on the film portion of the substrate, there is minimal absorption of inks which reduces drying requirements, saves ink, and minimizes the need to use drying ovens. As a result, the graphics printing can be done at a higher rate of speed and using less inks than an outer paper ply of conventional design.

Paper plies historically used within the bag industry exhibit a tendency to crack when folded during a bag-making operation. As a result, the gussets and bottom folds often exhibit a poor appearance and undesirable shelf appeal. Additionally, the crack impairs whatever barrier properties may have been present within the conventional outer ply layer. The present invention's use of a fabric backed biaxially oriented polypropylene or polyester has excellent flex characteristics. As a result, folds and creases resist cracking and thereby increase both the appearance and the barrier properties of the resulting bags.

Additionally, the fabric backed biaxially oriented films will readily receive an extruded or film applied heat seal coating such as a low density polyethylene. As such, the film substrate described herein is an ideal material for stand-up pouches and other containers where a heat sealed closure is desired.

Bags made according to the exemplary embodiments described above exhibit excellent resistance to grease migration through the packaging. Grease barriers are important with respect to packaged animal feed including dog food or cat food.

The strength of the substrate facilitates changes in one or more dimensions such as width, gusset size, or tube length of the constructed bags. As a result, bags having various dimensions including variations in center of gravity with respect to similar volume bags can be provided. Bags having a lower center of gravity typically place a greater stress on bag seams. The additional bag strength provided by the fabric backed biaxially oriented film allows for a sufficient bag strength such that variations in bag dimensions may be readily made without having to vary or increase materials used to construct the bag.

Although preferred embodiments of the invention have been described using specific terms, devices, and methods, such description is for illustrative purposes only. The words used are words of description rather than of limitation. It is to be understood that changes and variations may be made by those of ordinary skill in the art without departing from the spirit or the scope of the present invention, which is set forth in the following claims. In addition, it should be understood that aspects of the various embodiments may be interchanged, both in whole or in part. Therefore, the spirit and scope of the appended claims should not be limited to the description of the preferred versions contained therein.

That which is claimed is:

1. A bag comprising:
a tubular structure having upper and lower ends, the upper and lower ends being sealable;
front and back walls joined at opposite bag sides by at least two side gussets running the length of the bag; and,
a substrate of said bag having an outermost layer of a biaxially oriented thermoplastic film and an inner layer of a fabric backing.

2. An improvement in a gusset bag having at least an inner substrate and an outer ply, said improvement comprising said inner substrate comprising an oriented thermoplastic film having a fabric backing attached to at least one surface of the film.

3. A bag comprising:
a structure having upper and lower ends being sealable;
front and back walls joined at opposite back sides by at least gussets running a length of the bag;
an exterior surface of a bag substrate comprising a film layer, said film layer selected from the group consisting of biaxially oriented polypropylene films, biaxially oriented polyethylene films, and metallized films of biaxially oriented polypropylene; and
said film layer further comprising a fabric backing.

4. A bag comprising:
a tubular structure having upper and lower ends, the upper and lower ends being sealable; and,
a substrate of said bag having an outermost layer of a biaxially oriented thermoplastic film and an inner layer of a fabric backing.

5. The bag according to claim 4 wherein said fabric backing is selected from the group consisting of woven scrims, non-woven scrims, and spun bond scrims.
